(19) United States
(12) Patent Application Publication
(10) Pub. No.: US 2006/0041845 A1
(43) Pub. Date: Feb. 23, 2006

(54) Systems and methods for exchanging display data between machines

(75) Inventors: Alan L. Ferguson, Peoria, IL (US); Brian Lane Jenkins, Washington, IL (US); Trent Ray Meiss, Eureka, IL (US); Steven Wayne O'Neal, Bartonville, IL (US); Daniel Craig Wood, East Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/849,305

(22) Filed: May 20, 2004

(51) Int. Cl. G06F 17/00; G06F 3/00

(52) U.S. Cl. 715/751

(57) ABSTRACT

A method and system are provided for performing a process of exchanging display data between work machines. In one embodiment, the process includes displaying, at a first work machine, first display data associated with operations of the first work machine and sending the first display data to a second work machine. The first display data is then displayed at the second work machine. Further, the process includes generating, at the second work machine, feedback data based on the first display data and generating second display data based on the feedback data. The second display data is sent from the second work machine to the first work machine. The second display data is displayed at both the first work machine and the second work machine.

### TECHNICAL FIELD

This disclosure relates generally to work machine displays, and more particularly to systems and methods for exchanging display data between work machines.

### BACKGROUND

An important feature in modern work machines (e.g., fixed and mobile commercial machines, such as construction machines, fixed engine systems, marine-based machines, etc.) is machine mounted display devices. Today, operators of work machines use these devices to view many different aspects of a work machine operation. For example, in an earthworking operation, a work machine may implement a display that provides views of the terrain being manipulated by the machine. In some instances, the display may be updated in real time, allowing the operator to view a virtual representation of the progress of a particular operation being performed by the machine. Additionally, a display device may provide graphical representations of various parameter values associated with operations of the machine, such as temperature values, fuel levels, engine speed, emission levels, etc.

Although these devices enable an operator to view the progress and status of a work machine during a work operation, remote users are generally left to evaluate the machine based on physical and visual inspections of the machine and its progress at a work site. To address these shortcomings, systems have evolved that enable a user to view diagnostic and operation information associated with one or more remote work machines. Such a system is described in U.S. Pat. No. 6,295,492 (“the '492 patent”), issued to Lang et al. This system allows remote authorized users to receive real time data or historical information associated with one or more motor vehicles. Each vehicle is equipped with an on-board computer system and a translator device that converts diagnostic test signals into service codes presented in a standard computer language, such as ASCII files. The on-board computer wirelessly transmits the ASCII files to a center network server that stores the information in a database. From there, the authorized users may access the vehicle information to have it presented on a user interface.

Although conventional systems, such as that disclosed in the '492 patent, enable remote users to gain access to vehicle information, they do not allow a user to view the same information that is displayed to an operator of a remote machine during machine operation. Also, conventional systems do not allow the user to provide feedback to the operator through the display information. Further, these systems do not allow multiple work machines to share the display information for providing the feedback to an operator.

Methods, systems, and articles of manufacture consistent with certain disclosed embodiments are directed to solving one or more of the problems set forth above.

### SUMMARY OF THE INVENTION

A method and system are provided for performing a process of exchanging display data between work machines. In one embodiment, the process includes displaying, at a first work machine, first display data associated with operations of the work machine and sending the first display data to a second work machine. The first display data is then displayed at the second work machine. Further, the process includes generating, at the second work machine, feedback data based on the first display data and generating second display data based on the feedback data. The second display data is sent from the second work machine to the first work machine. The second display data is displayed at both the first work machine and the second work machine.

In another embodiment, a system for exchanging display data between work machines includes a subordinate work machine configured to generate first display data associated with operations of the subordinate work machine, wirelessly transmit the first display data, receive second display data, and display the first and second display data. Further, the system includes a supervisor work machine configured to receive the first display data from the subordinate work machine, display the first display data, and generate feedback data regarding operations of the subordinate work machine based on the first display data. Moreover, the supervisor work machine is configured to generate the second display data based on the feedback data and wirelessly transmit the second display data to the subordinate work machine.

### BRIEF DESCRIPTION OF THE DRAWINGS

The accompanying drawings, which are incorporated in and constitute a part of this specification, illustrate several aspects of the disclosure and together with the description, serve to explain the principles of the disclosure. In the drawings:

FIG. 1 illustrates a pictorial representation of an exemplary system that may be configured to perform certain functions consistent with certain disclosed embodiments;

FIG. 2 illustrates a block diagram of an on-board system consistent with certain disclosed embodiments;

FIG. 3 illustrates a pictorial representation of exemplary display data consistent with certain disclosed embodiments;

FIG. 4 illustrates a flowchart of an exemplary virtual display data process consistent with certain disclosed embodiments;

FIGS. 5A and 5B illustrate pictorial representations of exemplary display data consistent with certain disclosed embodiments;

FIGS. 6A and 6B illustrate pictorial representations of additional exemplary display data consistent with certain disclosed embodiments; and

FIGS. 7A and 7B illustrate pictorial representations of exemplary multi-work machine display data consistent with certain disclosed embodiments.

### DETAILED DESCRIPTION

Reference will now be made in detail to the exemplary embodiments are illustrated in the accompanying drawings. Wherever possible, the same reference numbers will be used throughout the drawings to refer to the same or like parts.

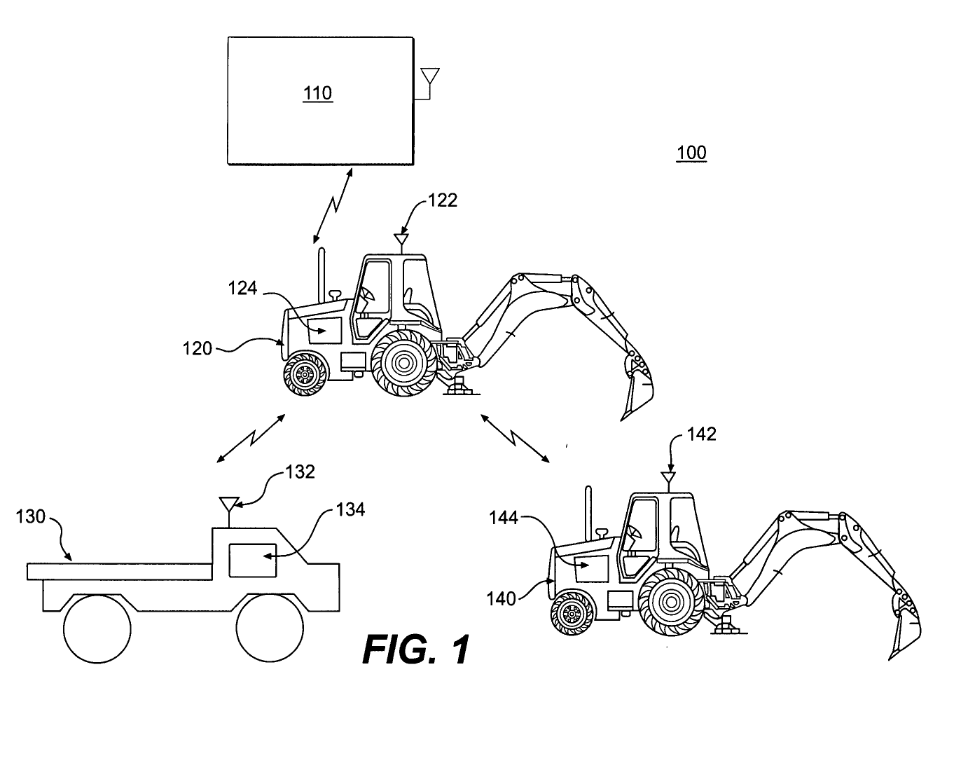

FIG. 1 illustrates an exemplary system 100 in which features and principles consistent with certain disclosed embodiments may be implemented. As shown in FIG. 1, system 100 may include a remote off-board system 110 and work machines 120, 130, and 140. Each work machine 120, 130, and 140 includes a wireless communication device, such as antennae 122, 132, and 142, and an on-board system 124, 134, and 144, respectively. Although only a specific number of work machines are shown, environment 100 may include any number and types of such machines and/or off-board systems.

Work machine, as the term is used herein, refers to a fixed or mobile machine that performs some type of operation associated with a particular industry, such as mining, construction, farming, etc. and operates between or within work environments (e.g., construction site, mine site, power plants, etc.). A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. As shown in FIG. 1, work machines 120 and 140 are backhoe type work machines, while machine 130 is a hauler-type work machine. The types of work machine illustrated in FIG. 1 are exemplary and not intended to be limiting. It is contemplated by the disclosed embodiments that environment 100 may implement any number of different types of work machines.

An off-board system, as the term is used herein, may represent a system that is located remote from work machines 120, 130, and 140. An off-board system may be a system that connects to work machine 120 through wireline or wireless data links. Further, an off-board system may be a computer system including known computing components, such as one or more processors, software, display, and interface devices that operate collectively to perform one or more processes. Alternatively, or additionally, an off-board system may include one or more communication devices that facilitates the transmission of data to and from work machine 120. In certain embodiments, an off-board system may be another work machine remotely located from work machine 120.

Remote off-board system 110 represents one or more computing systems associated with a business entity corresponding to work machines 120, 130, and 140, such as a manufacturer, dealer, retailer, owner, project site manager, a department of a business entity (e.g., service center, operations support center, logistics center, etc.), or any other type of entity that generates, maintains, sends, and/or receives information associated with machines 120, 130, and 140. Remote off-board system 110 may include one or more computer systems, such as a workstation, personal digital assistant, laptop, mainframe, etc. Remote off-board system 110 may include Web browser software that requests and receives data from a server when executed by a processor and displays content to a user operating the system. In one embodiment of the disclosure, remote off-board system 110 is connected to work machine 120 through a local wireless communication device. Remote off-board system 110 may also represent one or more portable, or fixed, service systems that perform diagnostics and/or service operations that include receiving and sending messages to work machine 120. For example, remote off-board system 110 may be an electronic testing device that connects to work machine through an RS-232 serial data link or through wireless communication mediums.

Wireless communication devices 122, 132, and 142 represent one or more wireless antennae configured to send and/or receive wireless communications to and/or from remote systems, such as off-board system 110 and other work machines. Although devices 122, 132, 142 are shown being configured for wireless communications, other forms of communications are contemplated. For example, work machines 120, 130, and 140 may exchange information with remote systems using any type of wireless, wireline, and/or combination of wireless and wireline communication networks and infrastructures. As shown in FIG. 1, work machines 120 may wirelessly exchange information with work machines 130 and 140, and off-board system 110.

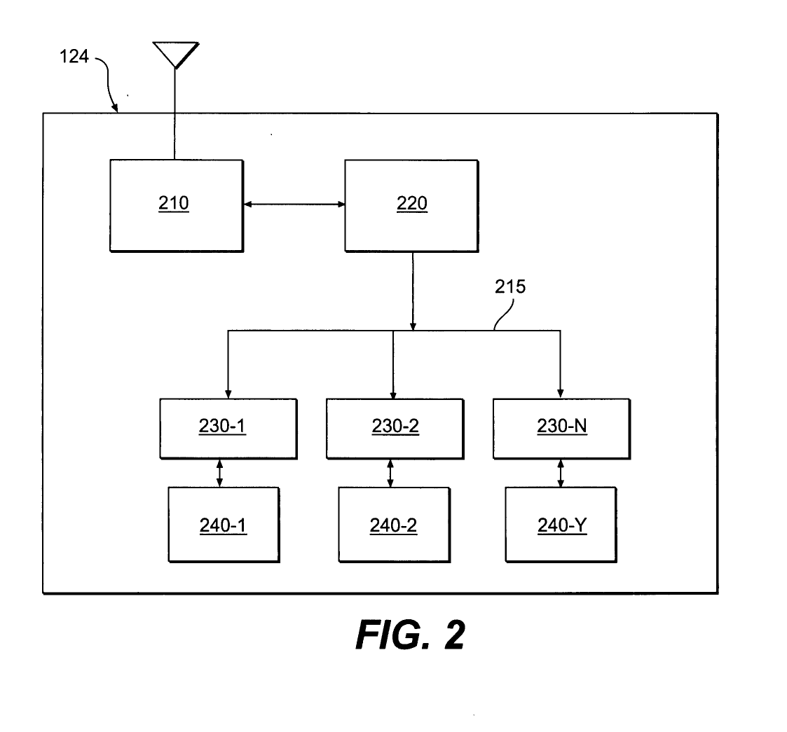

On-board systems 124, 134, and 144 represent a system of one or more on-board modules, interface systems, data links, and other types of components that perform machine processes within work machines 120, 130, and 140. FIG. 2 shows a block diagram of on-board system 124 consistent with certain disclosed embodiments. The following description of on-board system 124 is applicable to on-board systems 134 and 144.

As shown in FIG. 2, on-board system 124 may include a communication module 210, interface control system 220, on-board modules 230-1 to 230-N, and on-board components 240-1 to 240-Y. On-board modules 230-1 to 230-N and interface control system 220 are interconnected by one or more data links 215. Although interface control system 220 is shown as a separate entity, some embodiments may allow control system 220 to be included as a functional component of one or more of on-board modules. Further, although only a specific number of on-board control modules are shown, work machine 120 may include any number of such modules.

Communication module 210 represents one or more devices that are configured to facilitate communications between work machine 120 and one or more remote systems, such as off-board system 110 and other work machines 130, 140. Communication module 210 may include hardware and/or software that enables the device to send and/or receive data messages through wireline or wireless communications. As shown in FIGS. 1 and 2, communication module 210 is connected to communication device 122 for facilitating wireless communications with remote off-board system 110 and work machines 130, 140, although other off-board systems may send and receive data messages to and from communication module 210. The wireless communications may include satellite, cellular, infrared, and any other type of wireless communications that enables work machine 120 to wirelessly exchange information with an off-board system.

An on-board module, as the term is used herein, may represent any type of component operating in a work machine that controls or is controlled by other components or sub-components. For example, an on-board module may be an operator display device control module, an Engine Control Module (ECM), a power system control module, a Global Positioning System (GPS) interface device, an attachment interface that connects one or more sub-components, and any other type of device work machine 120 may use to facilitate operations of the machine during run time or non-run time conditions (i.e., machine engine running or not running, respectively).

Interface control system 220 represents an on-board interface device configured to perform functions consistent with embodiments of work machine 120. Interface control system 220 may be configured with various types of hardware and software depending on its application within work machine 120. Thus, in accordance with certain embodiments, interface control system 220 may provide interface capability that facilitates the transmission of data to and from communication module 210 and on-board modules 230-1 to 230-N. Further, interface control system 220 performs various data processing functions and maintains data for use by one or more on-board modules or off-board systems. For example, interface control system 220 may be configured to perform protocol conversions (e.g., tunneling and translations) and message routing services for on-board data links.

In one embodiment, interface control system 220 may include various computing components used to perform certain functions consistent with the requirements of that embodiment. To do so, interface control system 220 may include one or more processors and memory devices (not shown). For example, interface control system 220 may include a digital core that includes the logic and processing components used by interface control system 220 to perform interface, communications, and software update functionalities. In one embodiment, the digital core may include one or more processors and internal memories. The memories may represent one or more devices that temporarily store data, instructions, and executable code, or any combination thereof, used by a processor. Further, the memories may represent one or more memory devices that store data temporarily and/or permanently during operation of interface control system 220, such as a cache memory, register device, buffer, queuing memory device, and any type of memory device that maintains information. The internal memory used by interface control system 220 may be any type of memory device, such as flash memory, Static Random Access Memory (SRAM), and battery backed non-volatile memory devices.

In operation, the digital core may execute program code to facilitate communications between on-board modules and/or off-board systems. In one embodiment, interface control system 220 may include software that performs protocol conversion operations for converting information associated with one type of data link to another. The conversion operations may include protocol translation and tunneling features.

For clarity of explanation, FIG. 2 shows interface control system 220 as a distinct element. However, interface control functionality may be implemented via software, hardware, and/or firmware within one or more modules (e.g., 230-1 to 230-N) on an on-board data link. Thus, interface control system 220 may, in certain embodiments, represent functionality or logic embedded within another element of work machine 120.

Modules 230-1 to 230-N represent one or more on-board modules connected to data link 215 included in work machine 120. Data link 215 may represent one or more proprietary or non-proprietary data links, such as Society of Automotive Engineers (SAE) standard data links including Controller Area Network (CAN), J1939, etc. Data link 215 may be wireless or wireline. For example, in one embodiment, work machine 120 may include wireless sensors that are linked together through interface control system 220. Further, although FIG. 2 shows one data link 215, certain embodiments may include additional data links connected to one or more on-board modules 230-1 to 230-N that interconnect additional layers of on-board modules and/or interface control systems.

On-board components 240-1 to 240-Y represent one or more components that receive data, control signals, commands, and/or information from on-board modules, 230-1 to 230-N, respectively. In certain embodiments, on-board components 240-1 to 240-Y may be controlled by respective on-board modules 230-1 to 230-N through the execution of software processes within these modules. For example, on-board components 240-1 to 240-Y may represent different types of work machine components that perform various operations associated with the type of work machine 120. For instance, on-board module 240-1 may be one or more engine components, while on-board module 240-Y may represent one or more transmission type components.

In one embodiment, on-board components 240-1 to 240-Y include a display on-board component that provides display capabilities for work machine 120. For purposes of illustration only, on-board component 240-1 is a display component that is controlled by on-board module 230-1, hereinafter referred to as display module 230-1. Display component 240-1 may include hardware and software that allows work machine 120 to present one or more graphical displays to an operator of machine 120. Display module 230-1 may also include software and/or hardware that executes processes for providing the information displayed by component 240-1. In addition to an input port connected to data link 215, display module 230-1 may also include ports for receiving information from various sensor devices and machine positioning devices (not shown) that is used to generate the information displayed by component 240-1. Further, display component 240-1 may include multiple display devices that present different or the same information to an operator of machine 120.

In one embodiment, work machine 120 may implement devices that determine the position of one or more components of machine 120 (e.g., a bucket, swivel arm, etc.) and the position of work machine 120 relative to the work site, according to known techniques. Additionally, work machine 120 may implement one or more devices that determine the position of machine 120 relative to an entire work site, or a portion of the work site, based on global positioning information received from a GPS component. Display module 230-1 is configured to process this information and generate on-board display data that is rendered on a user-interface provided by display component 240-1.

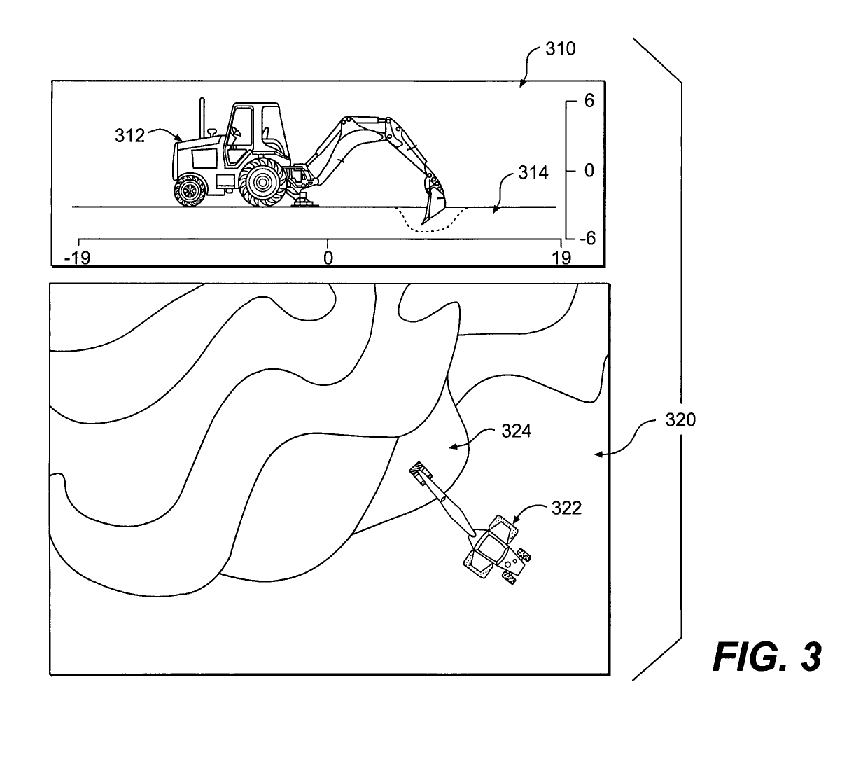

FIG. 3 illustrates a pictorial representation of exemplary on-board display data consistent with certain disclosed embodiments. In one embodiment, display component 240-1 may include a display device that provides multiple views 310 and 320 of work machine 120 as it operates within a work site. Views 310 and 320 may be presented in separate display devices or in separate graphical windows rendered within the same display device.

View 310 includes exemplary display data that may be generated by display module 230-1 based on information received from various machine on-board and off-board systems, components, sensors, etc. View 310 includes a graphical representation of work machine 120 (i.e., virtual machine 312) and a terrain surface 314 of a work site being manipulated by virtual machine 312. View 310 may or may not include parameter data reflecting positional and coordinate information relative to the terrain surface 314 and virtual machine 312.

View 320 includes additional exemplary display data that may be generated by display module 230-1. View 320 includes a different view (e.g., top view) having a graphical representation of work machine 120 (i.e., virtual machine 322) and the machine's relative work site. View 320 includes display data that provides an operator with real time information reflecting the terrain 324 being manipulated by work machine 120. Thus, the graphical representation of terrain 324 is updated based on the progress of work machine 120 manipulating actual terrain at the real work site. In one embodiment, views 310 and 320 may include mapping characteristics (i.e., color or shading attributes) that indicate to the operator of work machine 120 earth that is currently being manipulated, earth that has been manipulated, and earth that has not been manipulated. Also, views 310 and 320 may include mapping characteristics (i.e., colors, shading, etc.) that indicate the type of terrain or earth work machine is manipulating and/or within the work site. Other types of graphical representation attributes and characteristics may be implemented by the disclosed embodiments to allow a user to view the current or past progress of work machine 120, the status or condition of a work site, and the types of terrain, materials, earth, etc. manipulated by machine 120 at the work site.

As explained, views 310 and 320 represent graphical representations of work machine 120 and its respective work site in real time. Thus, as work machine 120 moves and performs various tasks within a work site, graphical representations 312, 314, 322, and 324 within views 310 and 320 are updated by display module 230-1 to reflect these tasks. Alternatively, or additionally, display module 230-1 may generate display data that includes graphical representations of a work site without a virtual work machine in a rendered view. This may be controlled by an operator or be performed automatically by software processes running with display module 230-1 and/or work machine 120.

In addition to, or alternatively, display module 230-1 may also generate display data reflective of one or more parameters and operational characteristics of work machine 120, such as fluid levels, fuel levels, fuel economy data, temperature levels, engine speed, ground speed, maintenance data, sensor data, and any other type of information reflecting various conditions, parameters, and operational status of one or more components of work machine 120. This information may be displayed by display component 240-1 in graphical or non-graphical form in one or more display devices. Further, the information may represent current and/or historical parameters and/or operational characteristics of work machine 120.

In certain embodiments, work machines 120, 130, and 140 (and other machines not shown) may be employed at different types of work sites to perform one or more tasks related to these sites. For example, work machines 120, 130, and 140 may operate at a construction work site where one or more buildings are being constructed. Also, work machines 120, 130, and 140 may operate at an excavation site where earthworking operations are performed, such as earth removal. Regardless of the type of work site, work machines 120, 130, and 140 may operate individually or collectively to perform one or more tasks associated with the site. Thus, in an earthworking site, work machine 120 may perform digging operations to excavate earth, while work machine 130 may perform hauling operations to remove the excavated earth from the work site.

In certain embodiments, one or more of work machines 120, 130, and 140 may be operated by skilled operators, such as a supervisor, or experienced individual associated with the type of work machine and/or the machine tasks for a work site. Other work machines may be operated by less skilled individuals. Typically, these less skilled operators require assistance in the operations of a work machine, the interpretation of information, alerts, etc. provided by a machine's on-board system, and/or in the use of the machine in performing a specified task at a work site. Implementing the disclosed embodiments, one or more experienced operators may provide such assistance to these inexperienced operators. A work machine that is operated by an individual who can provide assistance and instructions regarding the operation of, and/or interpretation of work machine related data for other work machines at a work site is considered a supervisor work machine. A work machine operated by any type of operator that requests or receives assistance or instructions from a supervisor work machine is considered a subordinate work machine. It is contemplated that in certain embodiments, a work machine may perform the role of both a supervisor and subordinate machine.

The “supervisor” and “subordinate” work machine identifiers are not intended to be limiting. That is, a subordinate work machine may be configured to operate similar to a supervisor work machine and, conversely, a supervisor work machine may be configured to operate as a subordinate work machine. While a supervisor work machine typically suggest a more experienced operator than a subordinate work machine, this may not always be the case.

A supervisor work machine may leverage the wireless communication and display capabilities consistent with the disclosed embodiments to provide assistance or information to subordinate machines. One type of assistance may be in the form of feedback data provided to a subordinate work machine from a supervisor machine. The feedback data may in the form of display data that is rendered on a display device within a subordinate work machine, voice data that is provided to a cellular or radio communication device within the subordinate work machine, or a combination of display and voice data. In certain embodiments, the feedback data may be dynamic or static. Dynamic feedback data is display data that is manipulated by an operator of a supervisor work machine and displayed in real time on a subordinate work machine's display device. Static feedback data may be display data that is provided to a subordinate work machine and displayed on a display device, but not dynamically manipulated by an operator of a supervisor work machine.

Although certain embodiments as described herein are in reference to one work machine sending feedback data to one or more other work machines, alternative uses for features of the disclosed embodiments may be implemented. For instance, an operator who is not skilled in a work site, or operations of a work machine, may implement features of the disclosed embodiments to provide information to another work machine other than in the form of assistance information or feedback data. Also, the “supervisor” and “subordinate” identifiers are not intended to be strictly associated with certain types of operators. Non-skilled operators may implement features of the disclosed embodiments to exchange feedback or other types of work machine related data between work machines.

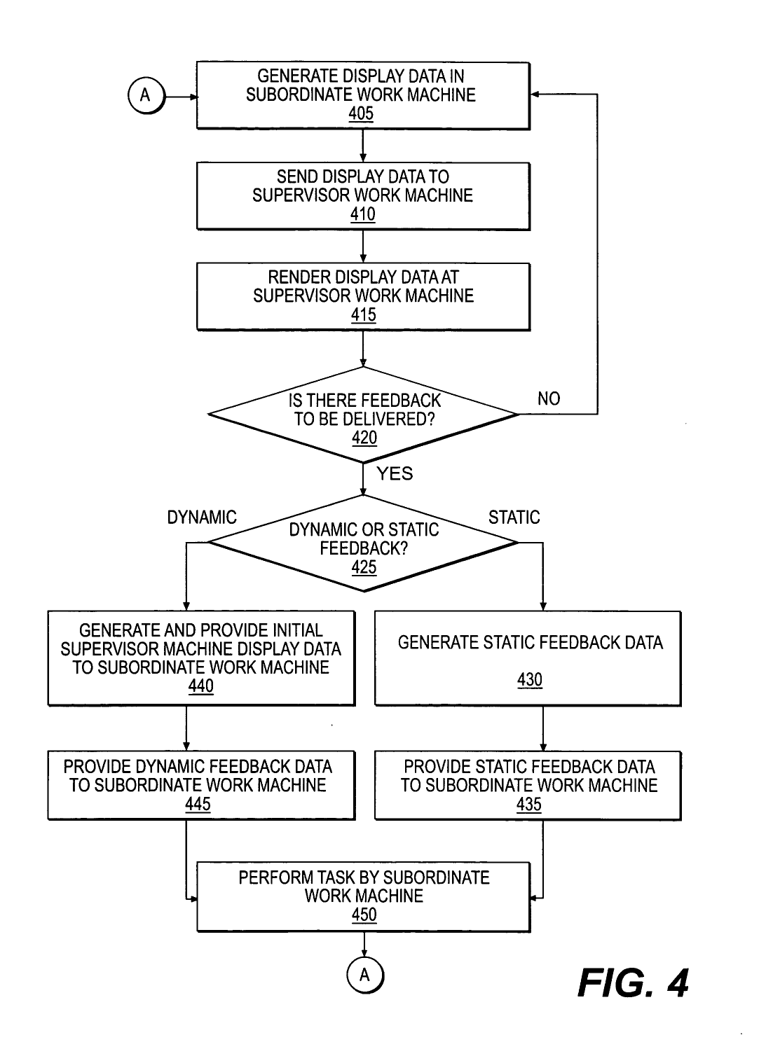

FIG. 4 illustrates a flowchart of an exemplary virtual display data process consistent with certain disclosed embodiments. To better describe features associated with these disclosed embodiment, the virtual display data process is described with reference to supervisor work machine 120 and subordinate work machine 140 (described above in connection with FIG. 1) performing one or more tasks at a earthworking site. Subordinate work machine 140 may perform some tasks associated with the work site, such as removing earth from a portion of the work site's terrain. While performing the task, subordinate work machine's 140 display module generates display data associated with machine's 140 performance (Step 405).

At some point during operation of the task, the operator of subordinate work machine 140 may have a question or comment regarding an event, condition, status, and/or strategy associated with the work machine's performance, and/or the performance of the task. Accordingly, the operator may instruct subordinate work machine 140 to deliver information in the form of display data, text data, and/or voice data including questions and/or comments. In one embodiment, subordinate work machine 140 may execute software that directs the machine to automatically deliver the information to another work machine, such as supervisor work machine 120. Such instances may be implemented when supervisor work machine 120 is configured to automatically receive display data from one or more subordinate work machines as the machines perform tasks at a work site.

In response to the user or software-based instructions, subordinate work machine 140 generates a message including the display data currently displayed by subordinate work machine's 140 display component. The message may also include information not displayed, such as operator comments, questions, suggestions, etc. Subordinate machine 140 then sends the display data to supervisor work machine 120 (Step 410). Accordingly, machine 140 may leverage its wireless communication module and device to transmit the display data over a wireless communication medium.

Once received, supervisor work machine 120 parses the message to collect the display data contained therein. Interface control system 220 may direct the display data to display module 230-1 for processing. Module 230-1 may process the display data into information that is rendered by display component 240-1, thus allowing supervisor work machine 120 to display all or a portion of the representations that are displayed on the display device in subordinate work machine 140 (Step 415).

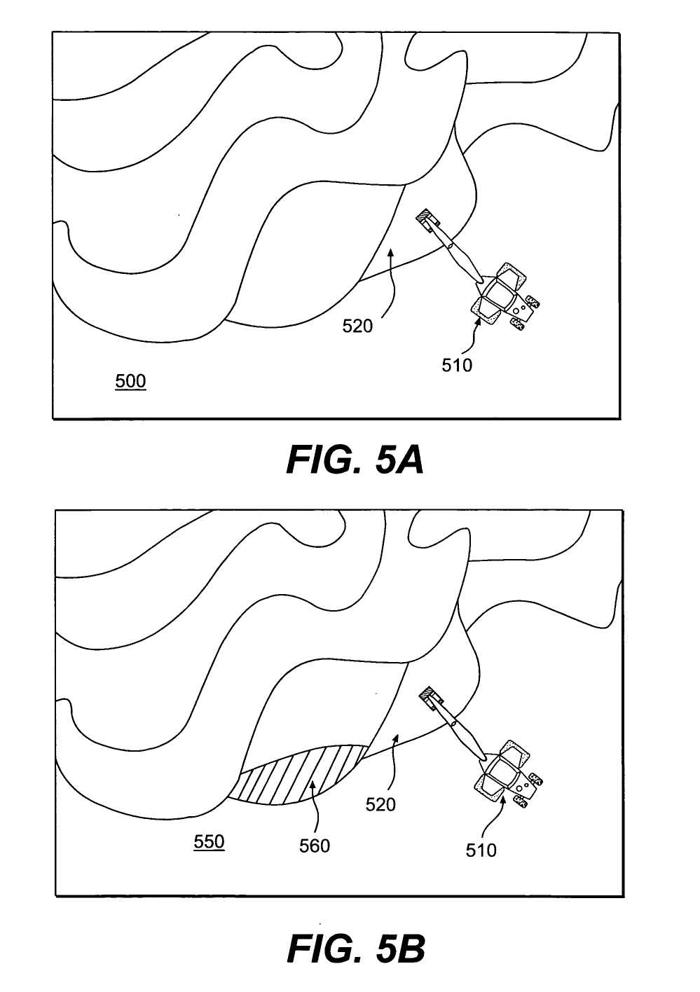

FIG. 5A shows a block diagram of a display 500 including exemplary display data that is rendered at both supervisor work machine 120 and subordinate work machine 140. As shown, display 500 includes a graphical representation of a virtual subordinate work machine 510 and a graphical representation of the work site terrain 520 that machine 510 is manipulating. Virtual work machine 510 is presented in a position that is relative to the actual position of subordinate work machine 140 in the work site.

Once displayed, the operator of supervisor work machine 120 may view and analyze the information represented by the display data associated with subordinate work machine 140. For example, the operator may determine whether subordinate work machine 140 is properly removing earth from the work site. Alternatively, or additionally, the analysis may be assisted, or supplemented, by software processes that perform one or more analysis functions on information provided in the message from subordinate work machine 120. For example, machine 120 may include a process executing on one or more on-board modules 230-1 to 230-N or interface control system 220 that performs comparative analysis of work site template data to current progress information extracted from the display data provided by subordinate work machine 140. For instance, supervisor work machine 120 may have one or more templates of display data reflecting how the work site, or portions thereof, should appear following completion of one or more tasks, such as the task being performed by machine 140. The comparative analysis software may compare the display data representing the current image of the work site as provided by subordinate work machine 140 with one or more of the templates to produce recommendations on subordinate work machine's 140 progress. The recommendations may include display data and textual instructions that indicate where in the work site machine 140 should perform additional tasks, where mistakes have been made in the work site, and new tasks that should be performed by machine 140. The recommendations may be provided to the operator of supervisor work machine 120 in a display device as graphical or non-graphical representations, such as a modified view of the work site. The operator may then analyze the recommendations.

Based on the analysis, the operator of supervisor work machine 120 may determine whether feedback should be provided to subordinate work machine 120 (Step 420). As explained, feedback may be static or dynamic. Accordingly, the operator of supervisor work machine 120 may determine the type of feedback based on the analysis of subordinate work machine's 140 performance in performing its task (Step 425).

If the operator of supervisor work machine 120 determines that static feedback is desired (Step 425; STATIC), the operator may use features of the disclosed embodiments to generate static feedback data (Step 430). For example, the operator may use an input device (e.g., mouse, finger or stylus for touch screen technologies, etc.) to manipulate the display data of the work site provided by subordinate work machine 120. FIG. 5B illustrates a display 550 including exemplary display data that is rendered and manipulated at supervisor work machine 140. As shown, the operator may modify the display data to include feedback indicating where on the work site virtual work machine 510 should perform its task. In the exemplary display 550, the operator marks a portion 560 of the virtual work site showing where subordinate work machine 140 should perform additional tasks, such as removing the earth reflected by marked portion 560.

Static feedback data is not limited to display data. The operator of supervisor work machine may also provide textual or voice feedback including instructions, comments, etc. reflecting the feedback associated with machine's 140 progress in performing its task.

Once the static feedback data is generated, supervisor work machine 120 may generate second display data including the feedback data, and provide the second display data to subordinate work machine 120 through communication module 210 (Step 435). Using static feedback enables the operator of supervisor work machine 120 to perform additional tasks once the static feedback data is delivered to subordinate work machine 140, such as communicating with other subordinate work machines, a central office, etc.

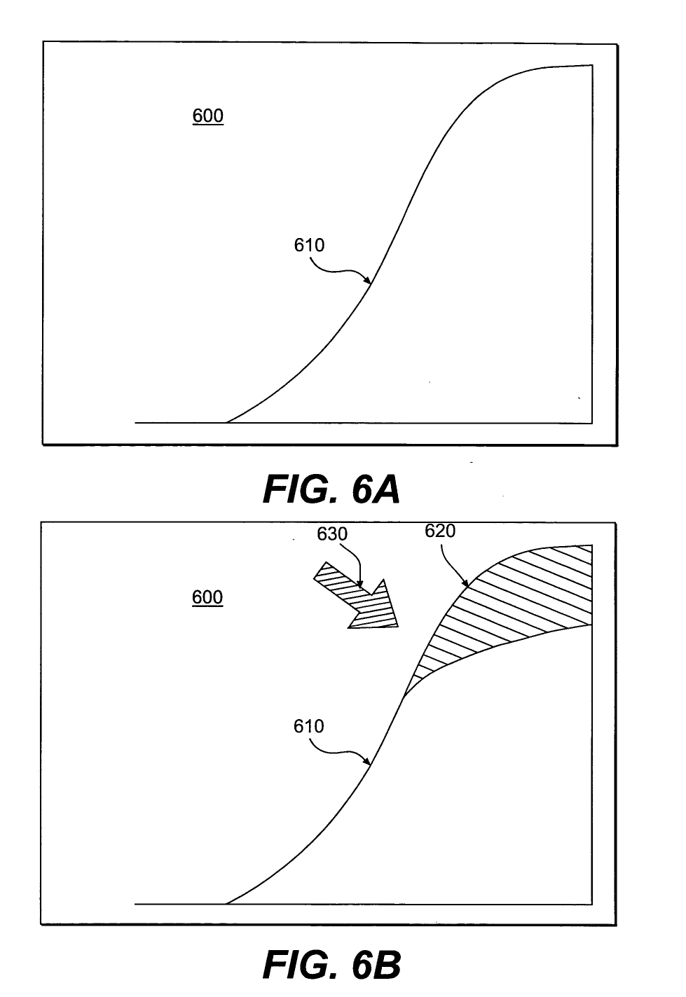

If, however, the operator of supervisor work machine 120 determines that dynamic feedback data is desired (Step 425; DYNAMIC), work machine 120 may generate and provide initial display data to subordinate work machine 140 (Step 440). The initial display data may be a graphical representation of the work site that is the same or different than the display data provided by subordinate work machine 140. For example, supervisor work machine 120 may send the same display data shown in FIG. 5A to subordinate work machine 140. Alternatively, supervisor work machine 120 may be configured to allow the operator to select or generate customized display data reflecting a different view of the work site, of work machine 140, or any other type of graphical representation. FIG. 6A illustrates a display 600 including exemplary initial display data that is generated by supervisor work machine 120. As shown, display 600 includes a graphical representation of a portion of the work site, such as a side view of terrain 610.

The initial display data is received and rendered on a display device in subordinate work machine 140, which may be an additional display device dedicated for feedback data purposes. Subsequently, the operator of supervisor work machine 120 may dynamically manipulate the initial display data rendered within machine 120 according to the type of feedback desired. As the operates makes changes to the display data, the changes may be sent in real time as feedback data to subordinate work machine 140 and rendered on its display device as second display data (Step 445). To better illustrate this embodiment, FIG. 6B illustrates display 600 including exemplary modifications suggested by the operator of supervisor work machine 120. As shown in FIG. 6B, the operator may use a graphical representation of a pointer 630 to move within display 600 to show changes 620 to terrain 610. The operator of subordinate work machine 140 sees these changes on the display device displaying the dynamic feedback data. At the same time, the operators of work machines 120 and 140 may communicate telephonically via a wireless communication channel, such as a cellular phone network.

Using dynamic feedback data, the operator of supervisor work machine may interact with subordinate work machine 140 in real time to assist in managing and monitoring the performance of machine 140 and the progress of the tasks associated with the work site.

Once the feedback data (dynamic or static) is provided and analyzed by the operators, the operator of subordinate work machine 120 may proceed with performing its task based on the feedback data (Step 450). For example, the operator may proceed with performing a task that is in response to the recommendations provided by supervisor work machine 120. As the task is being performed, subordinate work machine 140 may generate display data in a manner consistent with the features described above in connection with Step 405. The virtual display data process may then continue as explained above.

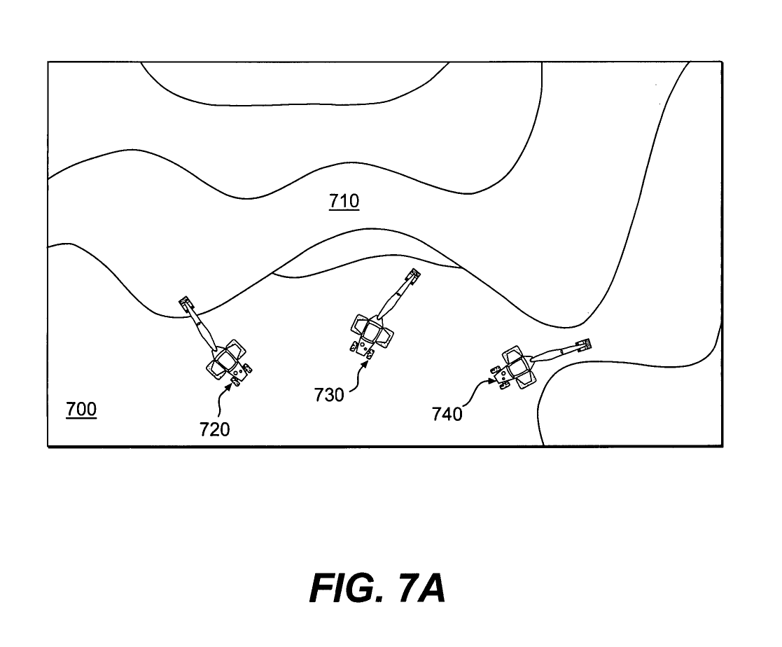

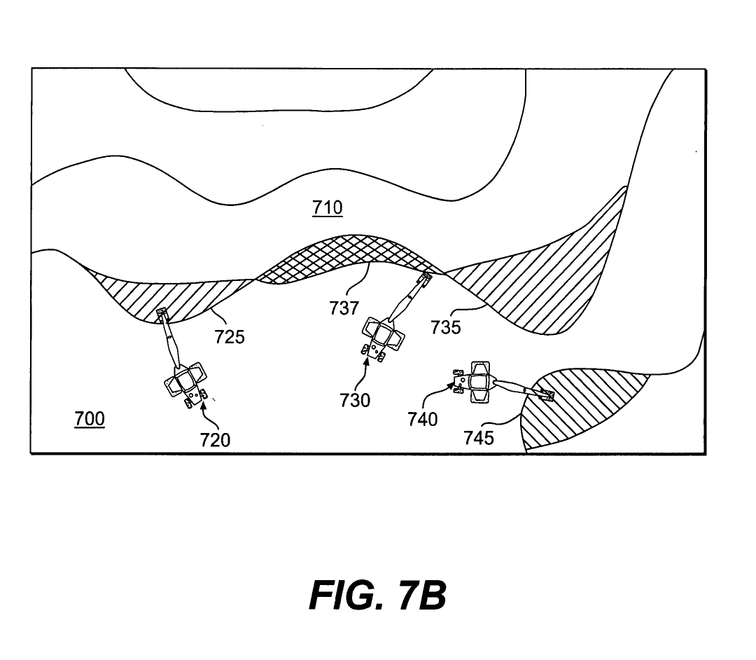

In addition to interacting with a single subordinate work machine, supervisor work machine 120 may also provide feedback data to multiple subordinate work machines performing respective tasks at a work site. In these embodiments, supervisor work machine 120 may receive display data representing individual display data provided by each of the subordinate work machines. Alternatively, supervisor work machine 120 may generate display data that represents a broader view of the work site and the work machines that are currently performing tasks within the site. FIG. 7A illustrates a display 700 that includes exemplary display data associated with these disclosed embodiments. As shown, display 700 includes a graphical representation of a work site terrain 710 and subordinate work machines 720, 730, and 740. The representations of work site terrain 710 and machines 720, 730, and 740 may be relative to real time positions and status of an actual work site and work machines performing tasks at the site. Supervisor work machine 120 may generate display 700 based on information provided by the actual subordinate work machines operating at the work site, or based on information provided by another work machine or off-board system 110.

The operator of supervisor work machine 120 may manipulate the display data rendered in display 700 in a manner consistent with that described above in connection with Steps 430-445 (dynamic or static feedback) to provide feedback to the subordinate work machines associated with virtual machines 720, 730, and 740. For example, to provide dynamic feedback data, supervisor work machine 120 may generate initial display data, such as display 700, and send the initial data to the subordinate work machines. At these machines, the initial display data is rendered on a respective display device for viewing by the operators of the subordinate machines. The operator of supervisor work machine 120 may then dynamically manipulate the display data and the changes reflected by the manipulations may be broadcasted in the form of second display data to the subordinate work machines for display in real time. Alternatively, the operator of supervisor work machine 120 may generate static feedback data in the form of graphical manipulations of display 700 and/or stored text and/or voice data files. Supervisor work machine 120 may then send the static feedback data in second display data to the subordinate work machines for subsequent display on respective display devices.

FIG. 7B illustrates display 700 following manipulations made by the operator of supervisor work machine 120. As shown, display 700 includes representations of tasks 725, 735, 737, and 745 reflecting operations to be performed by virtual work machines 720, 730, and 740. Task 725 shows a task that should be performed by subordinate work machine 720; task 735 and 737 show tasks to be performed by work machine 730; and task 745 shows a task that should be performed by subordinate work machine 740. Task 725, 735, 737, and 745 may be coded to match each work machine 720, 730, and 740, respectively. For example, different colors, shading, patterns, etc. may be used to graphically represent each subordinate work machine and corresponding task offered by the operator of supervisor work machine 120. Alternatively, different colors, shading, patterns, etc. may be used to reflect different types of tasks to be performed. For example, task 735 may represent a earth removal process that should be performed by subordinate work machine 730. Further, task 737 may represent a earth fill process that should be performed by the same machine 730. Thus, the operator of the subordinate work machine corresponding to virtual machine 730 may be instructed to remove the earth shown by task 735 and place it in the area designated by task 737.

The types of tasks, representations of a work site, work machines, etc. described above are exemplary and not intended to be limiting. Supervisor work machine 120 may generate display data showing different types of work machines that perform different types of tasks, and coordinate these tasks through the feedback data provided to these subordinate work machines in second display data. For instance, an operator of a hauler type work machine may be instructed to position the hauler machine in a certain position at a work site to collect earth being removed by one of the work machines associated with virtual subordinate work machines 720, 730, and 740.

### INDUSTRIAL APPLICABILITY

Methods and systems consistent with exemplary disclosed embodiments allow one or more work machines to exchange display data over a wireless communication network to facilitate the operation of the work machines or the performance of one or more tasks at a work site. In certain embodiments, a supervisor work machine is configured to receive display data from one or more subordinate work machines. Using the display data, the supervisor work machine may generate feedback data that may include, in certain instances, modified display data reflecting suggestions offered by an operator of the supervisor work machine. The subordinate work machine(s) may receive the suggestions dynamically or statically. That is, the operators of the subordinate work machines may receive feedback from the supervisor work machine in real time by viewing second display data showing graphical modifications offered by the supervisor work machine. Alternatively, the subordinate work machines may display feedback data after it has been generated by the supervisor work machine, without requiring real time feedback from the operator of the supervisor work machine.

By implementing the various features associated with the disclosed embodiments, supervisor work machine 120 may manage and monitor the progress of one or more tasks being performed by subordinate work machines 130, 140 at a work site. Additionally, supervisor work machine 120 may provide feedback data in the form of technical advice regarding non-work site progress information. For example, work machine 120 may provide feedback data representing maintenance suggestions, operation of a work machine (e.g., RPM settings, machine component angle settings, gear settings, etc.) and any other form of feedback data that may be delivered and used by an operator of a subordinate work machine. Thus, an operator of a subordinate work machine that requires assistance on the type of attachment to use for a particular task, an alert event provided by an on-board system, etc. may receive feedback data in the form of display data generated by supervisor work machine 120. Such display data may include schematics of the subordinate work machine, instructions on how to correct a problem detected by the subordinate work machine's on-board system, contacts of individuals to call, instructions how to operate the subordinate work machine while performing certain tasks, etc. Accordingly, the disclosed embodiments are not limited to any particular type of feedback data.

In one embodiment, work machines 120, 130, and 140 may include hardware and/or software that indicating a mode associated with the display data presented by their respective display components (e.g., component 240-1). For example, work machine 120 may include a process for designating which data displayed by display component 240-1 is associated with that machine's display data and which data displayed is associated with a subordinate work machine's display data. The designation may be an indicator message, a signal, a graphical border, an illuminated light source (e.g., LED), text, etc. that identifies a particular view within a display device, or a display device, as presenting subordinate or supervisor display data. Thus, if work machine 120 includes two separate display devices, a mode indicator may be presented in relation to each individual display device when displaying certain types of display data (i.e., subordinate or supervisor display data). Alternatively, if a single display device is implemented that presents multiple views representing subordinate and supervisory display data, respectively, appropriate designators may be produced to distinguish the two views allowing an operator to identify the view presenting supervisor display data and the view presenting subordinate display data.

In addition to display data, as described in the disclosed embodiments, methods and systems consistent with these embodiments may also produce display data that provides feedback on measurable performance attributes associated with work machines while operating in a work site. For example, referring to FIGS. 7A and 7B, work machines 720, 730, and 740 may be assigned respective tasks that collectively perform an aggregate task or job. For example, work machine 720's task is associated with terrain 725; work machine 730's task is associated with terrain 737, and work machine 740's task is associated with terrain 745. Collectively, tasks 725, 737, and 745 produce an aggregate task or job of producing a wider path for work site 710.

Methods and systems consistent with the disclosed embodiments may allow a supervisor work machine to collect progress information associated with tasks 725, 737, and 745 by viewing and analyzing display data associated with these tasks. The supervisor work machine may compare a measurable attribute, such as terrain manipulated, associated with each of these tasks against an aggregate value for these tasks and corresponding to the aggregate task or job. Based on this analysis, the supervisor machine may produce a quantitative value representing the performance of each of work machines 720, 730, and 740 in relation to their respective tasks 725, 737, and 745, and the aggregate task or job. This information may be combined to produce progress display data that is sent to each of the subordinate work machines 720, 730, and 740 for display on their respective display devices.

The progress display data may indicate or identify which work machines are performing their respective tasks at an acceptable level, which machines are exceeding their expected performance, and which machines are performing a level below their expected performance. The progress display data may be in the form of textural or graphical information. For example, a subordinate work machine may receive progress display data that is similar to that displayed in FIG. 7B. Included in the exemplary display data may be identifiers that provide performance information associated with each work machine 720, 730, and 740. The identifiers may be text that lists the amount of terrain moved by each machine, and the amount moved in relation to the other work machines, as well as a performance evaluation value (e.g., 100% efficiency, 80% efficiency, etc.). Further, the progress display data may use graphical data to indicate different performance levels for each work machine, such as color coded graphics associated with performance for appropriate work machines (e.g., green for acceptable performance and red for unacceptable performance). These examples are not intended to be limiting and any type of progress display data may be generated and presented in work machines 120, 130, and 140 to provide measurable attributes associated with work machine performance in performing tasks at a work site.

The embodiments, features, aspects, and principles of the disclosed exemplary systems may be implemented in various environments and are not limited to work site environments. For example, a supervisor work machine may communicate with subordinate work machines that are traveling between job sites, geographical locations, etc. For example, a supervisor work machine may be traveling with one or more subordinate work machines on a highway to a predetermined destination. The supervisor work machine may send display data including directions to a particular destination that is displayed to the operators of the subordinate work machines. In accordance with certain disclosed embodiments, the display data may be manipulated by the operator of the supervisor work machine to show certain tasks (i.e., directions, speeds, etc.) that each subordinate work machine should perform in accordance with the travels. Further, the processes disclosed herein are not inherently related to any particular system and may be implemented by a suitable combination of electrical-based components. Embodiments other than those expressly described herein will be apparent to those skilled in the art from consideration of the specification and practice of the disclosed systems. It is intended that the specification and examples be considered as exemplary only, with a true scope of the invention being indicated by the following claims.

What is claimed is:

1. A method for exchanging display data between work machines, comprising:
displaying, at a first work machine, first display data associated with operations of the work machine;
sending the first display data to a second work machine;
displaying the first display data at the second work machine;
generating, at the second work machine, feedback data based on the first display data;
generating second display data based on the feedback data;
sending the second display data from the second work machine to the first work machine; and
displaying the second display data on the first work machine and the second work machine.

2. The method of claim 1, wherein the first display data includes data reflecting graphical representations of the first work machine and its relative position in a work site, and wherein displaying the first display data at the second work machine includes:
displaying the first display data in the second work machine such that an operator of the second work machine views the graphical representations.

3. The method of claim 1, wherein the first display data includes at least one of:
data reflecting graphical representations of the first work machine and its relative position in a work site;
operational data reflecting one or more parameter values of the first work machine; and
event data associated with one or more events experienced by the first work machine.

4. The method of claim 1, wherein generating feedback data includes:
analyzing the first display data to determine at least one of:
a progress of the first work machine in performing a first task,
an operational status of the first work machine,
an operational status of one or more components of the first work machine, and
one or more parameters values associated with respective parameters associated with the operations of the first work machine.

5. The method of claim 1, wherein generating feedback data includes:
analyzing the first display data to determine a recommendation associated with the operation of the first work machine; and
generating the feedback data based on the recommendation.

6. The method of claim 1, wherein generating feedback data includes:
determining whether dynamic or static feedback data should be provided to the first work machine; and
generating either static or dynamic feedback data based on the determination.

7. The method of claim 6, wherein generating static feedback data includes:
modifying the first display data at the second work machine based on input from an operator of the second work machine; and
generating the static feedback data based on the modification.

8. The method of claim 7, wherein generating the second display data includes:
generating the second display data based on the static feedback data, wherein the second display data includes data reflecting a modified version of the first display data.

9. The method of claim 8, wherein displaying the second display data at the first work machine includes:
displaying the modified version of the first display data such that an operator of the first work machine views the modifications to the first display data.

10. The method of claim 1, wherein the feedback data includes suggestions made by an operator of the second work machine associated with a performance of the first work machine in performing a first task.

11. The method of claim 1, wherein the feedback data includes instructions made by an operator of the second work machine for the first work machine to perform a specified task.

12. The method of claim 11, wherein the instructions are at least one of visual, audio, and textual-based instructions.

13. The method of claim 12, wherein the instructions are included in the second display data, and wherein when the instructions are at least one of textual and visual-based instructions, the first work machine displays the second display data on a display device, and wherein when the instructions are audio-based instructions, the first work machine plays audio sounds reflective of the audio-based instructions.

14. The method of claim 6, wherein generating dynamic feedback data includes:
generating initial display data based on the first display data;
sending the initial display data to the first work machine; and
displaying the initial display data at the first work machine.

15. The method of claim 14, further including:
generating dynamic feedback data using the initial display data;
generating the second display data based on the dynamic feedback data; and
displaying the second display data at the first work machine such that the dynamic feedback data is displayed at the first work machine as the dynamic feedback data is generated and displayed at the second work machine.

16. The method of claim 6, wherein the dynamic feedback data includes modifications made to the first display data by an operator of the second work machine and wherein the second display data includes a visual representation reflecting the modifications to the first display data.

17. The method of claim 1, wherein the feedback data includes visual manipulations made to the first display data as it is displayed at the second work machine.

18. The method of claim 17, wherein displaying the second display data includes displaying the visual manipulations at the first work machine as they are made and displayed at the second work machine.

19. The method of claim 1, wherein the first display data and the second display data are sent wirelessly.

20. A system for exchanging display data between work machines in a work site, comprising:
a subordinate work machine configured to generate first display data associated with operations of the subordinate work machine, wirelessly transmit the first display data, receive second display data, and display the first and second display data; and
a supervisor work machine configured to receive the first display data from the subordinate work machine, display the first display data, generate feedback data regarding operations of the subordinate work machine based on the first display data, generate the second display data based on the feedback data, and wirelessly transmit the second display data to the subordinate work machine.

21. The system of claim 20, wherein the first display data includes data reflecting graphical representations of the subordinate work machine and its relative position in a work site, and wherein the supervisor work machine is further configured to display the first display data to an operator of the supervisor work machine.

22. The system of claim 20, wherein the first display data includes at least one of:
data reflecting graphical representations of the subordinate work machine and its relative position in a work site;
operational data reflecting one or more parameter values of the subordinate work machine; and
event data associated with one or more events experienced by the subordinate work machine.

23. The system of claim 20, wherein the supervisor work machine generates the feedback data by analyzing the first display data to determine at least one of:
a progress of the subordinate work machine in performing a first task,
an operational status of the subordinate work machine,
an operational status of one or more components of the subordinate work machine, and
one or more parameters values associated with respective parameters associated with the operations of the subordinate work machine.

24. The system of claim 20, wherein an operator of the supervisor work machine generates the feedback data by analyzing the first display data to determine at least one of:
a progress of the subordinate work machine in performing a first task,
an operational status of the subordinate work machine,
an operational status of one or more components of the subordinate work machine, and
one or more parameters values associated with respective parameters associated with the operations of the subordinate work machine.

25. The system of claim 20, wherein an operator of the supervisor work machine analyzes the displayed first display data to determine a recommendation associated with the operation of the subordinate work machine and generates the feedback data based on the recommendation.

26. The system of claim 25, wherein the operator of the supervisor work machines generates the feedback data by editing the first display data and the supervisor work machine generates the second display data based on the feedback data.

27. The system of claim 20, wherein the supervisor work machine is configured to generate static and dynamic feedback data.

28. The system of claim 27, wherein the supervisor work machine generates either static or dynamic feedback data based input received from an operator of the supervisor work machine.

29. The system of claim 28, wherein the supervisor work machine generates static feedback data by allowing the operator to modify the first display data and generating the static feedback data based on the modification.

30. The system of claim 29, wherein the supervisor work machine generates the second display data based on the static feedback data, wherein the second display data includes data reflecting a modified version of the first display data.

31. The system of claim 30, wherein the subordinate work machine displays the second display data by displaying the modified version of the first display data to allow an operator of the subordinate work machine to view the modifications to the first display data.

32. The system of claim 20, wherein the feedback data includes suggestions made by an operator of the supervisor work machine associated with a performance of the subordinate work machine in performing a task.

33. The system of claim 20, wherein the feedback data includes instructions made by an operator of the supervisor work machine for the subordinate work machine to perform a specified task.

34. The system of claim 33, wherein the instructions are at least one of visual, audio, and textual-based instructions.

35. The system of claim 34, wherein the instructions are included in the second display data, and wherein when the instructions are at least one of textual and visual-based instructions, the subordinate work machine displays the second display data on a display device, and wherein when the instructions are audio-based instructions, the subordinate work machine plays audio sounds reflective of the audio-based instructions.

36. The system of claim 27, wherein the supervisor work machine generates dynamic feedback data by generating initial display data based on the first display data, sending the initial display data to the subordinate work machine, and wherein the subordinate work machine displays the initial display data.

37. The system of claim 36, wherein the supervisor work machine is configured to:
generate dynamic feedback data using the initial display data and input received by an operator of the supervisor work machine, and generate the second display data based on the dynamic feedback data, and
wherein the subordinate work machine is configured to display the second display data as the dynamic feedback data is generated and displayed at the supervisor work machine.

38. The system of claim 27, wherein the dynamic feedback data is modifications made to the first display data by an operator of the supervisor work machine and wherein the second display data includes a visual representation reflecting the modifications to the first display data.

39. The system of claim 20, wherein the feedback data includes graphical modifications made by an operator to the first display data displayed at the supervisor work machine.

40. The system of claim 39, wherein the subordinate work machine displays the second display data as the second display data is generated and displayed at the supervisor work machine.

41. A system for exchanging display data between work machines, including:
a set of subordinate work machines each configured to:
generate first display data reflecting operations of the respective subordinate work machine,
wirelessly transmit the first display data,
receive second display data, and
display the first and second display data; and
a supervisor work machine configured to:
receive the first display data from each of the subordinate work machine,
generate work site display data based on the received first display data, wherein the work site display data includes graphical representations of a work site and of each of the subordinate work machines relative to their position in the work site,
generate feedback data based on the work site display data and input received from an operator of the supervisor work machine,
generate the second display data based on the feedback data, and
wirelessly transmit the second display data to the subordinate work machine,
wherein each of the subordinate work machines displays the second display data such that an operator of each of the subordinate work machines may review the feedback data provided by the supervisor work machine.

42. A method for exchanging display data between work machines, comprising:
displaying graphical representations of a work site and at least one subordinate work machine at a supervisor work machine, wherein the graphical representations reflect a real time image of the at least one subordinate work machine relative to the work site;
modifying at least one of the graphical representations based on input received from an operator of the supervisor work machine;
sending the modified graphical representations to the subordinate work machine for display on a display device at the subordinate work machine; and
performing a task using the subordinate work machine based on the modified graphical representations displayed at the subordinate work machine.

43. A system for providing feedback between work machines, comprising:
means for displaying, at a first work machine, first display data associated with operations of the work machine;
means for sending the first display data to a second work machine;
means for displaying the first display data at the second work machine;
means for generating, at the second work machine, feedback data based on the first display data;
means for generating second display data based on the feedback data;
means for sending the second display data from the second work machine to the first work machine; and
means for displaying the second display data on the first work machine and the second work machine.
